(19) United States
(12) Patent Application Publication
(10) Pub. No.: US 2025/0211154 A1
(43) Pub. Date: Jun. 26, 2025

(54) LINEAR MOTOR DRIVE DEVICE AND LINEAR MOTOR

(71) Applicant: Mitsubishi Electric Corporation, Tokyo (JP)

(72) Inventors: Akira SATAKE, Tokyo (JP); Kenji TAKAHASHI, Tokyo (JP); Tatsuya KAWASE, Tokyo (JP); Hiroki MORIKAWA, Tokyo (JP)

(73) Assignee: Mitsubishi Electric Corporation, Tokyo (JP)

(21) Appl. No.: 18/850,079

(22) PCT Filed: Mar. 30, 2023
(86) PCT No.: PCT/JP2023/013167

§ 371 Date: Sep. 24, 2024

(30) Foreign Application Priority Data
Apr. 5, 2022 (WO) PCT/JP2022/017090

(51) Int. Cl. H02P 25/064

(52) U.S. Cl. CPC H02P 25/064

(57) ABSTRACT

This linear motor drive device includes: a stator on which a plurality of coils connected in series are disposed to be arrayed; a plurality of half-bridges; and a switching controller including a half-bridge output voltage calculator. Both ends of a series unit of the coils and connection points between the coils are each connected to an output point of a different one of the half-bridges. AC voltages are applied to the respective coils. The half-bridge output voltage calculator obtains, through calculation, output voltage references for the respective half-bridges on the basis of application voltage references for voltages to be applied to the respective coils. The switching controller obtains switching signals for controlling switches of the half-bridges by using the respective half-bridge output voltage references having been obtained.

### TECHNICAL FIELD

The present disclosure relates to a linear motor drive device and a linear motor.

### BACKGROUND ART

A linear motor is composed of: a stator on which a plurality of coils are arrayed; and movable elements disposed with gaps between the stator and the movable elements and each implemented by a permanent magnet that is moved in a direction in which the coils of the stator are arrayed. A technology regarding the linear motor has been embodied as products. The technology proposes individually controlling currents flowing through the respective coils of the stator so that, in particular, a plurality of the movable elements are independently controlled to add new value to the linear motor. In the conventional technology, in order to realize the individual control of currents for the respective coils, a type is employed in which full-bridge or half-bridge single-phase inverters are connected to the respective coils, and voltages are individually applied to the respective coils (for example, FIG. 2a and FIG. 2b in Patent Document 1).

In addition, the following type of linear motor drive device has been known (for example, Patent Document 2). That is, this linear motor drive device is for a DC linear motor in which: a plurality of arrayed coils are electrically connected in series; and output points of half-bridge circuits, in each of which switches are connected in series, are connected to connection points between the coils. The linear motor drive device applies a voltage of a DC power supply as an input for each of the half-bridges and controls, by a logic circuit that receives a signal from a position sensor, each of the switches so as to cause a DC current to flow through the corresponding coil. Thus, the linear motor drive device drives the DC linear motor.

### CITATION LIST

### Patent Document

Patent Document 1: U.S. Patent No. 2019/0386588
Patent Document 2: Japanese Laid-Open Patent Publication No. 64-1466

### SUMMARY OF THE INVENTION

### Problem to be Solved by the Invention

In the type disclosed in Patent Document 1, the degree of freedom in the waveforms of voltages capable of being applied to the respective coils is high. However, in a case where two switches are used for one coil as in a half-bridge, the maximum value of the voltage capable of being applied to the coil is restricted to half the voltage of the DC power supply. In addition, in order to apply the voltage of the DC power supply to the coil such that the voltage has positive and negative polarities, four switches are necessary for one coil as in a full-bridge, whereby the number of the switches is double the number in the case where a half-bridge is used.

Meanwhile, the drive type for the linear motor disclosed in Patent Document 2 is a drive type in which conduction to a positive power supply or a negative power supply by a brush in the DC linear motor has been merely substituted with switching of a half-bridge. Therefore, arbitrarily-determined voltages cannot be applied to the respective coils, and the degree of freedom in controlling movement of a movable element is very low.

The present disclosure has been made to solve the above problems, and an object of the present disclosure is to provide a linear motor drive device in which: the number of switches is small; the degree of freedom in the waveforms of voltages to be applied to respective coils is high; a voltage of a DC power supply can be applied so as to have positive and negative polarities; and the degree of freedom in controlling movement of a movable element is high.

### Means to Solve the Problem

A linear motor drive device according to the present disclosure is a linear motor drive device including: a stator on which a plurality of coils are disposed to be arrayed; half-bridges each formed by a series unit of a plurality of switches, the number of the half-bridges being larger, by one, than the number of the coils; and a switching controller including a half-bridge output voltage calculator, wherein the plurality of coils are electrically connected in series, both ends of a series unit of the coils connected in series and connection points between the coils are each connected to an output point of a different one of the half-bridges, both ends of each of the half-bridges are connected to a DC source, AC voltages are applied to the respective coils, the half-bridge output voltage calculator obtains, through calculation, output voltage references for the respective half-bridges on the basis of application voltage references for voltages to be applied to the plurality of respective coils, and the switching controller obtains switching signals for controlling the switches of the half-bridges by using the half-bridge output voltage references for the respective half-bridges obtained by the half-bridge output voltage calculator and controls drive of the switches of all the half-bridges.

### Effect of the Invention

The present disclosure makes it possible to provide a linear motor drive device in which: the number of switches is small; the degree of freedom in the waveforms of voltages to be applied to respective coils is high; a voltage of a DC power supply can be applied so as to have positive and negative polarities; and the degree of freedom in controlling movement of a movable element is high.

### BRIEF DESCRIPTION OF THE DRAWINGS

FIG. 1 is a schematic circuit diagram showing a configuration of a linear motor drive device according to embodiment 1.

FIG. 2 is a schematic diagram showing a configuration of a generally-used linear motor.

FIG. 3 is a block diagram showing the configuration of the linear motor drive device according to embodiment 1, the block diagram also including a movable element.

FIG. 4 shows a structure of a switching controller of the linear motor drive device according to embodiment 1.

FIG. 5 shows graphs of an example of the waveforms of induced voltages generated in coils of the linear motor drive device according to embodiment 1.

FIG. 6 shows, with waveforms, an example of switching operations of the linear motor drive device according to embodiment 1.

FIG. 7 is a block diagram showing a configuration of a linear motor drive device according to embodiment 2.

FIG. 8 shows graphs of an example of the waveforms of induced voltages generated in coils of the linear motor drive device according to embodiment 2.

FIG. 9 shows an internal structure of a half-bridge output voltage calculator 81 of a linear motor drive device according to embodiment 3.

FIG. 10 shows graphs of an example of the waveforms of induced voltages generated in coils of the linear motor drive device according to embodiment 3.

FIG. 11 shows graphs of another example of the waveforms of induced voltages generated in coils of the linear motor drive device according to embodiment 3.

FIG. 12 shows graphs of still another example of the waveforms of induced voltages generated in coils of the linear motor drive device according to embodiment 3.

FIG. 13 is a block diagram showing a configuration of a linear motor drive device according to embodiment 4.

FIG. 14 is a block diagram showing another configuration of the linear motor drive device according to embodiment 4.

FIG. 15 is a block diagram showing an internal structure of a coil current calculator in the configuration, in FIG. 14, of the linear motor drive device according to embodiment 4.

FIG. 16 is a block diagram showing a configuration of a linear motor drive device according to embodiment 5.

FIG. 17 shows a structure of a switching controller of the linear motor drive device according to embodiment 5.

FIG. 18 shows graphs of an example of the waveforms of induced voltages generated in the coils of the linear motor drive device according to embodiment 5.

FIG. 19 shows graphs of another example regarding the waveforms of the induced voltages generated in the coils of the linear motor drive device according to embodiment 5.

FIG. 20 shows a graph of still another example regarding the waveforms of the induced voltages generated in the coils of the linear motor drive device according to embodiment 5.

FIG. 21 shows graphs of still another example regarding the waveforms of the induced voltages generated in the coils of the linear motor drive device according to embodiment 5.

FIG. 22 shows an internal structure of a current controller 100 in the configuration, in FIG. 16, of the linear motor drive device according to embodiment 5.

FIG. 23 shows internal structures of integral calculators 1030 to 1035 in the configuration, in FIG. 22, of the linear motor drive device according to embodiment 5.

FIG. 24 shows graphs of an example of the waveforms of voltages to be applied to the coils and the waveforms of currents in the linear motor drive device according to embodiment 5.

FIG. 25 shows graphs of another example of the waveforms of the voltages to be applied to the coils and the waveforms of the currents in the linear motor drive device according to embodiment 5.

FIG. 26 is a block diagram showing an example of a specific configuration of the switching controller in the linear motor drive device according to the present disclosure.

### DESCRIPTION OF EMBODIMENTS

### Embodiment 1

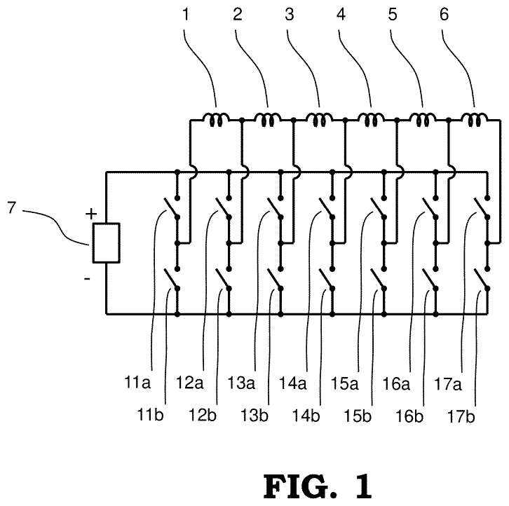

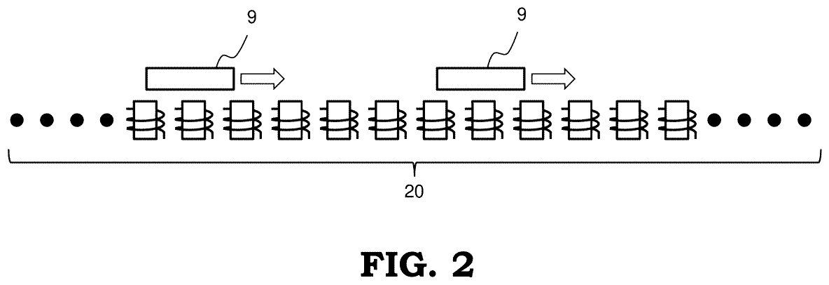

FIG. 1 is a schematic circuit diagram showing a configuration of a linear motor drive device according to embodiment 1, and FIG. 2 is a schematic diagram showing a configuration of a generally-used linear motor. As shown in FIG. 2, the linear motor is composed of: a stator 20; and movable elements 9 disposed with gaps between the stator 20 and the movable elements 9 and each implemented by a permanent magnet. The stator 20 has a configuration in which a plurality of coils are disposed to be arrayed. The movable elements 9 are moved in a direction in which the coils of the stator 20 are arrayed. In FIG. 1, a coil 1 to a coil 6 are coils wound on the stator 20 of the linear motor. The coil 1 disposed at a one-side end has: one end connected to the connection point between a switch 11a and a switch 11b connected in series; and another end connected to one end of the coil 2 and to the connection point between a switch 12a and a switch 12b connected in series. The coil 2 has another end connected to one end of the coil 3 and to the connection point between a switch 13a and a switch 13b connected in series. Likewise, the coils 3, 4, 5, and 6 are connected in series, and the connection points between these coils are connected to the connection point between a switch 14a and a switch 14b connected in series, the connection point between a switch 15a and a switch 15b connected in series, and the connection point between a switch 16a and a switch 16b connected in series, respectively. The coil 6 disposed at an other-side end has another end connected to the connection point between a switch 17a and a switch 17b connected in series. In addition, each pair of switches connected in series have both ends connected to a positive (+) side and a negative (−) side of a common DC power supply 7 and receive power therefrom.

In this manner, in the linear motor drive device according to embodiment 1, the coils of the stator in the linear motor are connected in series, and the outputs of half-bridges in each of which a plurality of corresponding switches are connected in series are connected to both ends of a series unit of the coils and the connection points between the coils. Although FIG. 1 shows an example of the linear motor drive device in which the number of the coils of the stator is six, the linear motor drive device according to the present disclosure has a configuration in which: the number of the coils is arbitrarily determined; and N+1 half-bridge circuits are connected to N coils. However, in general, four or more coils are necessary for exhibiting an effect due to possession of the plurality of independent coils of the stator with respect to the actual movement operations of the movable elements. Thus, the linear motor drive device according to the present disclosure becomes effective when: the number of the coils is four or more; and the number of the half-bridge circuits is five or more.

A basic operation of the linear motor drive device according to embodiment 1 will be described. The coil 1, the switches 11a and 11b, and the switches 12a and 12b compose a full-bridge circuit. Thus, when the four switches 11a, 11b, 12a, and 12b are switched, a voltage Vdc of the DC power supply 7 can be applied to the coil 1 in a forward/reverse direction. In addition, when the switches are switched at a high speed, an intermediate voltage can also be applied to the coil on average. Likewise, a full-bridge circuit for each of the coils is composed of the corresponding switches connected to both ends of the coil. Thus, the drive circuit in FIG. 1 can apply, to each of the coils, an AC voltage having an amplitude in a range from a minimum value −Vdc to a maximum value +Vdc in the same manner as a conventional full-bridge circuit such as one described in Patent Document 1, for example. As a matter of course, a voltage only on the positive side or the negative side of AC might be applied to a certain coil depending on the movements of the movable elements to be controlled.

Meanwhile, comparison in terms of the number of the switches is made as follows. That is, the conventional configuration in which one full-bridge circuit is connected to each of the coils needs to be configured with switches, the number of which is 4 times the number of the coils, whereas the linear motor drive device according to embodiment 1 is configured with switches, the number of which equals (number of coils+1)×2. For example, in the case where the number of the coils is six as shown in FIG. 1, the conventional full-bridge circuit needs to be configured with 24 switches, whereas the circuit in FIG. 1 enables a drive circuit to be configured with 14 switches. Thus, it is found that the number of the switches can be significantly decreased.

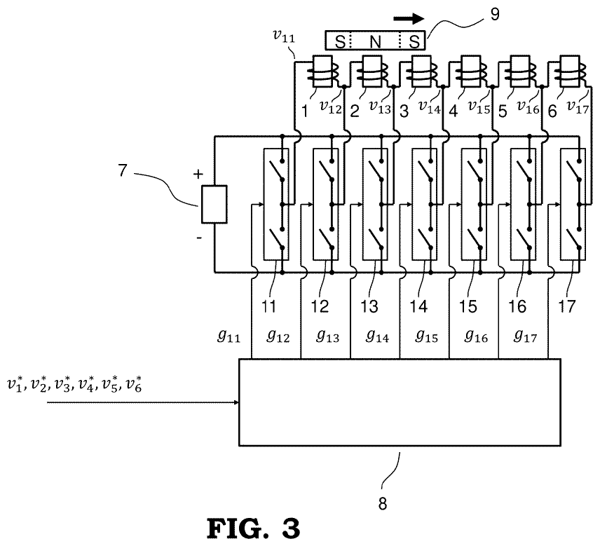

Next, operation of the linear motor drive device according to embodiment 1 will be described. FIG. 3 is a block diagram showing the configuration of the linear motor drive device according to embodiment 1, the block diagram also including a movable element 9 of the linear motor. FIG. 3 shows an example in which the movable element 9 of the linear motor has permanent-magnet magnetic poles (an N pole and S poles). In this example, voltages to be applied to the respective coils 1 to 6 are changed according to the position and the speed of the movable element 9 and the thrust to be generated by the movable element 9. In FIG. 3, the switch 11a and the switch 11b are collectively shown as a half-bridge 11, and the same applies to the other half-bridges 12 to 17.

Application voltage references for the voltages to be applied to the respective coils 1, 2, 3, 4, 5, and 6 in order to control the linear motor are respectively represented by v₁*, v₂*, v₃*, v₄*, v₅*, and v₆*. A switching controller 8 calculates switching signals g₁₁, g₁₂, g₁₃, g₁₄, g₁₅, g₁₆, and g₁₇ on the basis of these application voltage references v₁* to v₆* and outputs these switching signals to the respective half-bridges 11 to 17. When any of the switching signals indicates 1, the corresponding half-bridge turns on the upper-side switch thereof and turns off the lower-side switch thereof. In contrast, when the switching signal indicates 0, the half-bridge turns off the upper-side switch thereof and turns on the lower-side switch thereof.

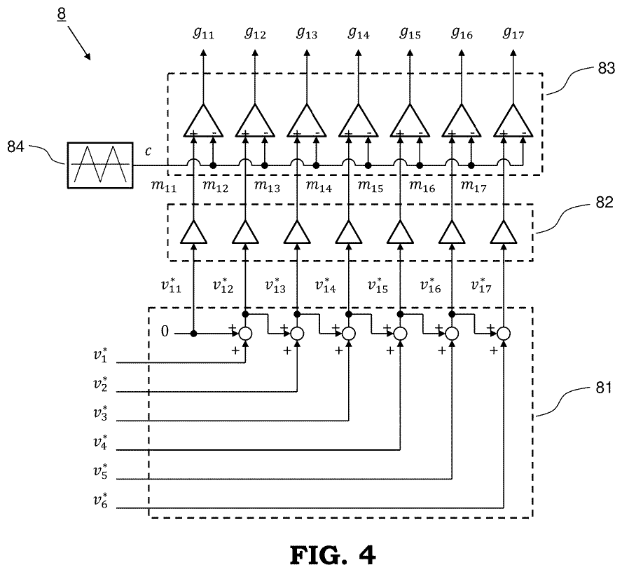

FIG. 4 shows a structure of the switching controller 8 of the linear motor drive device according to embodiment 1. The application voltage references v₁* to v₆* for the respective coils are inputted to a half-bridge output voltage calculator 81 and converted by internal adders into half-bridge output voltage references v₁₁*, v₁₂*, v₁₃*, v₁₄*, v₁₅*, v₁₆*, and v₁₇* expressed with the expressions presented below. Each of the application voltage references is defined, with a terminal on the right side of the corresponding coil being regarded as a positive terminal and with a terminal on the left side of the coil being regarded as a negative terminal. Here, the half-bridge output voltage reference v₁₁* for the half-bridge 11 (also referred to as first half-bridge) to which one end of the series unit of the six coils is connected, is set to 0 as a reference voltage. Each of the application voltage references is calculated for the corresponding coil by using characteristic parameters of the linear motor on the basis of the position and the speed of the movable element relative to the coil, a desired value of current to be caused to flow through the coil, and the like. The calculated application voltage references are represented by v₁* to v₆*.

$${v}_{11}^{*} = 0 \\ {v}_{12}^{*} = {v}_{11}^{*} + {v}_{1}^{*} \\ {v}_{13}^{*} = {v}_{12}^{*} + {v}_{2}^{*} \\ {v}_{14}^{*} = {v}_{13}^{*} + {v}_{3}^{*} \\ {v}_{15}^{*} = {v}_{14}^{*} + {v}_{4}^{*} \\ {v}_{16}^{*} = {v}_{15}^{*} + {v}_{5}^{*} \\ {v}_{17}^{*} = {v}_{16}^{*} + {v}_{6}^{*}$$

A modulation factor calculator 82 multiplies the half-bridge output voltage references v₁₁* to v₁₇* by 2/V_{dc} which is a gain, to calculate respective half-bridge modulation factors m₁₁ to m₁₇. Here, V_{dc} is an application voltage, for each of the half-bridges, that is outputted from the DC power supply 7.

A carrier generator 84 generates a carrier wave c (e.g., triangular wave) for performing pulse width modulation. In the case of FIG. 4, the triangular wave varies between −1 and 1 according to the relationship with the gain in the modulation factor calculator 82. A comparator 83 performs comparison, in terms of magnitude, between each of the half-bridge modulation factors m₁₁ to m₁₇ inputted from the modulation factor calculator 82 and the carrier wave c inputted from the carrier generator 84. When the modulation factor has a larger value, the comparator 83 outputs 1 as the corresponding one of the switching signals g₁₁ to g₁₇ to the corresponding half-bridge. Meanwhile, when the carrier wave has a larger value, the comparator 83 outputs 0 as the corresponding one of the switching signals g₁₁ to g₁₇ to the corresponding half-bridge.

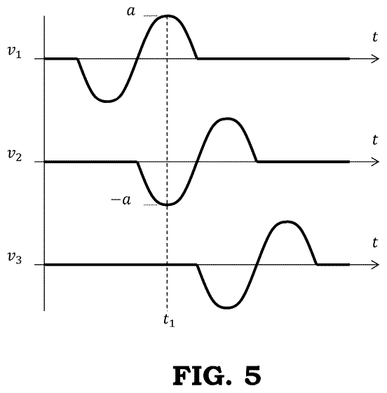

FIG. 5 shows the waveforms of induced voltages that, when the movable element 9 is moved over the coils 1 to 3 at a fixed speed as shown in FIG. 3, have been generated in the coils owing to permanent-magnet magnetic fluxes of the movable element 9. In FIG. 5, the induced voltage of the coil 1 is represented by v₁, the induced voltage of the coil 2 is represented by v₂, the induced voltage of the coil 3 is represented by v₃, and the horizontal axis indicates time point t (elapse of time). In the linear motor shown in FIG. 3, a magnetic-pole pitch (the distance between the center of the N pole and the center of each of the S poles) of the movable element 9 and the distance between adjacent ones of the independently wound coils are equal to each other. Thus, in a case where the induced voltage generated when the movable element 9 passes a certain one of the coils is assumed to correspond to one cycle of a sine wave, the induced voltage of a coil adjacent to the certain coil has a waveform with a phase shifted from the phase of the sine wave by 180°, as shown in FIG. 5.

In order to, for example, prevent the movable element 9 from generating any thrust at this time, the currents that flow through the respective coils only have to be set to 0. To this end, voltages equal to the induced voltages of the respective coils only have to be applied to the coils. In this case, at a time point t₁ in FIG. 5, the application voltage references v₁* to v₆* for the respective coils are as follows. Although not shown in FIG. 5, all the application voltages for the coils 4, 5, and 6 at the time point t₁ are 0.
v₁*=a
v₂*=−a
v₃*=0
v₄*=0
v₅*=0
v₆*=0

The application voltage references are inputted to the half-bridge output voltage calculator 81 of the switching controller 8, and the following half-bridge output voltage references v₁₁* to v₁₇* are calculated.

$${v}_{11}^{*} = 0 \\ {v}_{12}^{*} = {v}_{11}^{*} + {v}_{1}^{*} = a \\ {v}_{13}^{*} = {v}_{12}^{*} + {v}_{2}^{*} = 0 \\ {v}_{14}^{*} = {v}_{13}^{*} + {v}_{3}^{*} = 0 \\ {v}_{15}^{*} = {v}_{14}^{*} + {v}_{4}^{*} = 0 \\ {v}_{16}^{*} = {v}_{15}^{*} + {v}_{5}^{*} = 0 \\ {v}_{17}^{*} = {v}_{16}^{*} + {v}_{6}^{*} = 0$$

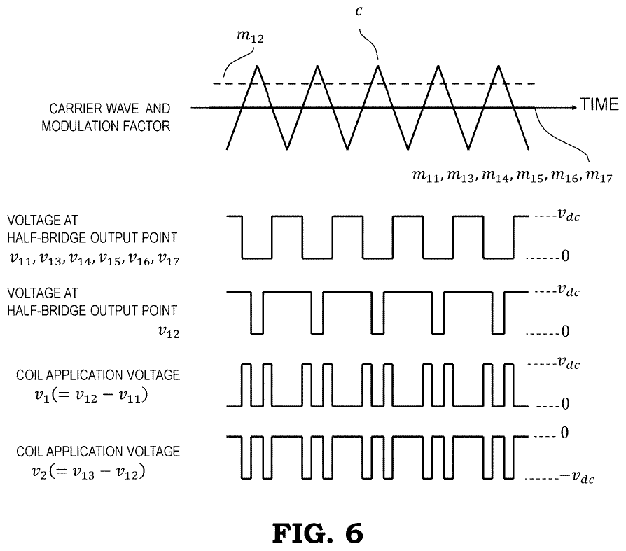

FIG. 6 shows, with waveforms, an example of switching operations of the drive circuit described above. The modulation factor calculator 82 calculates half-bridge modulation factors m₁₁ to m₁₇ from the respective half-bridge output voltage references v₁₁* to v₁₇*, and the comparator 83 generates switching signals g₁₁ to g₁₇ from the modulation factors and the carrier wave c. As described above, the modulation factors result from multiplying the respective half-bridge output voltage references by 2/V_{dc} which is a gain, i.e., result from dividing the respective half-bridge output voltage references by V_{dc}/2. One example is as follows. That is, a half-bridge, the modulation factor for which is 0.5, keeps the positive-side switch thereof ON for a period that is 50% of the cycle of the carrier wave, whereas a half-bridge, the modulation factor for which is −0.5, keeps the negative-side switch thereof ON for a period that is 50% of the cycle of the carrier wave. Another example is as follows. That is, in a case where the modulation factor is 1, the half-bridge keeps the positive-side switch thereof ON for a period during which the modulation factor is 1, whereas, in a case where the modulation factor is −1, the half-bridge keeps the negative-side switch thereof ON for a period during which the modulation factor is −1. In a case where the modulation factor is larger than 1, the half-bridge keeps the positive-side switch thereof ON for a period during which the modulation factor is larger than 1, in the same manner as in the case where the modulation factor is 1. Meanwhile, in a case where the modulation factor is smaller than −1, the half-bridge keeps the negative-side switch thereof ON for a period during which the modulation factor is smaller than −1, in the same manner as in the case where the modulation factor is −1. In this manner, each of the modulation factors is the proportion of the period during which the positive-side or negative-side switch of the corresponding half-bridge is to be kept ON. The half-bridges are driven according to the switching signals based on these respective modulation factors. Accordingly, voltages v₁₁ to v₁₇ are applied from the output points of the respective half-bridges shown in FIG. 3 to both ends of the coils 1 to 6. FIG. 6 shows the voltages from the output points of the respective half-bridges. The voltage to be applied to each of the coils is the difference between the voltages outputted from the corresponding half-bridges connected to both ends of the coil. To each of the coils, a voltage corresponding to the application voltage reference for the coil such as the coil application voltage v₁, v₂ shown in FIG. 6 is applied on average. The coils 3, 4, 5, and 6 receive, at both ends thereof, the same voltage from the output points of the respective half-bridges, and thus the coil application voltages of the coils 3, 4, 5, and 6 are 0. Although a case where the thrust to be generated by the movable element 9 is set to 0 has been described above, the movable element 9 can be caused to generate a desired thrust or perform a desired operation, by adjusting the application voltage references for the respective coils. Although a method for performing pulse width modulation with a triangular wave in generation of an intermediate voltage between −V_{dc} and +V_{dc} has been described above, it is needless to say that the advantageous effects are exhibited also by employing another voltage generation method.

The above operation enables the linear motor drive device according to embodiment 1 to, as compared to a conventional drive device in which a full-bridge circuit is used (such as one described in, for example, Patent Document 1), significantly decrease the number of necessary switches and apply an arbitrarily-determined positive or negative voltage having a magnitude of up to the voltage of the DC power supply to the coils in the same manner as the conventional full-bridge circuit. Consequently, it is possible to realize a linear motor drive device having a degree of freedom in control equivalent to that of the conventional type while decreasing the size of and cost for the drive circuit.

### Embodiment 2

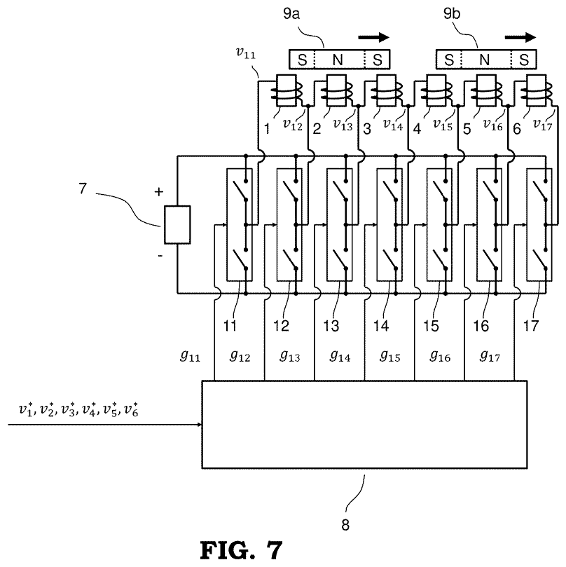

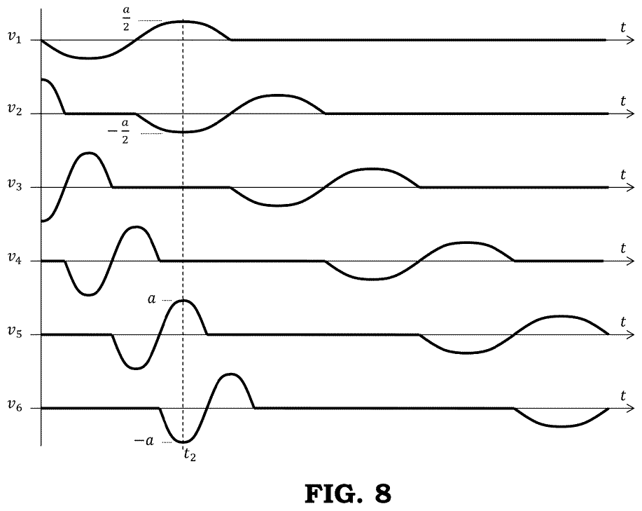

FIG. 7 is a block diagram showing a configuration of a linear motor drive device according to embodiment 2 and shows an example in which two movable elements 9a and 9b are driven. FIG. 8 shows the waveforms of induced voltages generated in the coils owing to permanent-magnet magnetic fluxes of the movable elements when: the movable elements 9a and 9b are present at the positions shown in FIG. 7 and are being moved at fixed speeds in the direction indicated by the arrows; and the movable element 9a is being moved at a speed that is half the speed of the movable element 9b. In FIG. 8, the induced voltage of the coil 1 is represented by v₁, the induced voltage of the coil 2 is represented by v₂, the induced voltage of the coil 3 is represented by v₃, the induced voltage of the coil 4 is represented by v₄, the induced voltage of the coil 5 is represented by v₅, and the induced voltage of the coil 6 is represented by v₆. The linear motor shown in FIG. 7 is such that: the relationship between the magnetic-pole pitch of each of the movable elements and the distance between the coils is the same as that in FIG. 3; induced voltages generated in adjacent ones of the coils by the movable element being moved at the fixed speed are in the forms of sine waves that have waveforms with phases shifted from each other by 180°; and each of the sine waves has an amplitude proportional to the movement speed of the movable element. In FIG. 8, the amplitude of an induced voltage generated in a coil by the movable element 9b is represented by a.

In order to, for example, prevent the movable elements 9a and 9b from generating any thrust at this time, the currents that flow through the respective coils only have to be set to 0. To this end, voltages equal to the induced voltages of the respective coils only have to be applied to the coils. In this case, at a time point t₂ in FIG. 8, the application voltage references v₁* to v₆* for the respective coils are as follows.

$${v}_{1}^{*} = a / 2 \\ {v}_{2}^{*} = - a / 2 \\ {v}_{3}^{*} = 0 \\ {v}_{4}^{*} = 0 \\ {v}_{5}^{*} = a \\ {v}_{6}^{*} = - a$$

The application voltage references are inputted to the half-bridge output voltage calculator 81 of the switching controller 8, and the following half-bridge output voltage references v₁₁* to v₁₇* are calculated.

$${v}_{11}^{*} = 0 \\ {v}_{12}^{*} = {v}_{11}^{*} + {v}_{1}^{*} = a / 2 \\ {v}_{13}^{*} = {v}_{12}^{*} + {v}_{2}^{*} = 0 \\ {v}_{14}^{*} = {v}_{13}^{*} + {v}_{3}^{*} = 0 \\ {v}_{15}^{*} = {v}_{14}^{*} + {v}_{4}^{*} = 0 \\ {v}_{16}^{*} = {v}_{15}^{*} + {v}_{5}^{*} = a \\ {v}_{17}^{*} = {v}_{16}^{*} + {v}_{6}^{*} = 0$$

On the basis of signals generated by the switching controller 8 according to the above respective half-bridge output voltage references in the same manner as in embodiment 1, the respective half-bridges 11 to 17 are operated so as to apply desired voltages to the respective coils. Although a case where the thrust to be generated by each of the movable elements 9a and 9b is set to 0 has been described above, each of the movable elements 9a and 9b can be caused to generate a desired thrust or perform a desired operation, by adjusting the application voltage references for the respective coils. Although a case where the number of the movable elements is two and the number of the coils is six has been described in the above example, it is needless to say that the operation can be performed even with a combination of a plurality of the movable elements and coils, the numbers of which are respectively larger than two and six. That is, control is performed with inclusion of the application voltage references, for the respective coils, obtained when at least two movable elements are present at positions corresponding to the series unit of the coils connected in series, whereby the plurality of movable elements can be caused to perform desired operations.

The above actions enable the linear motor drive device according to embodiment 2 to, as compared to a conventional drive device (such as one described in, for example, Patent Document 1), significantly decrease the number of necessary switches, set a high degree of freedom in controlling movements of the movable elements, and cause the plurality of movable elements to perform desired operations in the same manner as the conventional circuit. Consequently, it is possible to realize the same functions as those of the conventional type while decreasing the size of and cost for the drive circuit.

### Embodiment 3

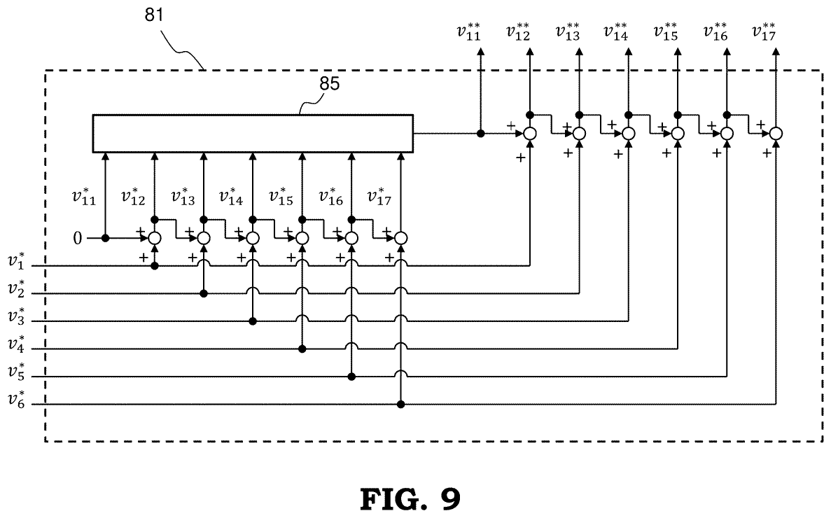

FIG. 9 shows an internal structure of a half-bridge output voltage calculator 81 of a linear motor drive device according to embodiment 3. The other constituents in embodiment 3 are the same as those in embodiments 1 and 2. In order to explain an advantageous effect of the half-bridge output voltage calculator 81 shown in FIG. 9, characteristics of the respective half-bridge output voltage references v₁₁* to v₁₇* in the present disclosure will be described first. A linear motor in which the magnetic-pole pitch (the distance between the center of the N pole and the center of each of the S poles) of the movable element 9 and the distance between adjacent ones of the independently wound coils are equal to each other as shown in FIG. 3 is as described in embodiment 1. That is, when the movable element 9 is moved over the coils at a fixed speed, induced voltages (such as ones shown in FIG. 5) are generated in the respective coils owing to permanent-magnet magnetic fluxes of the movable element 9. Thus, the half-bridge output voltage references v₁₁* to v₁₇*, which are described again as follows, are required at the time point t₁.

$${v}_{11}^{*} = 0 \\ {v}_{12}^{*} = {v}_{11}^{*} + {v}_{1}^{*} = a \\ {v}_{13}^{*} = {v}_{12}^{*} + {v}_{2}^{*} = 0 \\ {v}_{14}^{*} = {v}_{13}^{*} + {v}_{3}^{*} = 0 \\ {v}_{15}^{*} = {v}_{14}^{*} + {v}_{4}^{*} = 0 \\ {v}_{16}^{*} = {v}_{15}^{*} + {v}_{5}^{*} = 0 \\ {v}_{17}^{*} = {v}_{16}^{*} + {v}_{6}^{*} = 0$$

The time point t₁ is one of time points at which the difference between the maximum value and the minimum value among the half-bridge output voltage references v₁₁* to v₁₇* becomes largest. The maximum value and the minimum value among the half-bridge output voltage references v₁₁* to v₁₇* are respectively a and 0. It is found that, in this case, the half-bridge output voltage references are unevenly on the positive side. The unevenness of the half-bridge output voltage references leads to increase in the absolute values of the modulation factors. In the relationship between carrier wave and modulation factor shown in FIG. 6, when any of the modulation factors becomes larger than 1 which is a peak of the carrier wave or becomes smaller than −1 which is also a peak of the carrier wave, the corresponding half-bridge output voltage does not follow the modulation factor, whereby a correct voltage cannot be outputted.

In order to eliminate the unevenness of the half-bridge output voltage references and maximally ensure half-bridge output voltages, an appropriate value instead of 0 which is a reference voltage only has to be applied to v₁₁* which is a reference for the half-bridge output voltage references. For example, since the maximum value and the minimum value among v₁₁* to v₁₇* are respectively a and 0, a value −a/2 for canceling a/2 which is the average of the maximum value and the minimum value only has to be newly applied, as a corrected reference voltage, to the output voltage reference v₁₁* for the half-bridge 11. Consequently, corrected half-bridge output voltage references v₁₁** to v₁₇** obtained by the correction are as follows. It can be understood that, through the above process, the maximum value and the minimum value among the half-bridge output voltage references have been respectively corrected to a/2 and −a/2 to eliminate the unevenness of the half-bridge output voltage references while the application voltage references v₁* to v₆* for the coils are maintained, as in the following results.

$${v}_{11}^{**} = - a / 2 \\ {v}_{12}^{**} = {v}_{11}^{**} + {v}_{1}^{*} = a / 2 \\ {v}_{13}^{**} = {v}_{12}^{**} + {v}_{2}^{*} = - a / 2 \\ {v}_{14}^{**} = {v}_{13}^{**} + {v}_{3}^{*} = - a / 2 \\ {v}_{15}^{**} = {v}_{14}^{**} + {v}_{4}^{*} = - a / 2 \\ {v}_{16}^{**} = {v}_{15}^{**} + {v}_{5}^{*} = - a / 2 \\ {v}_{17}^{**} = {v}_{16}^{**} + {v}_{6}^{*} = - a / 2$$

Operation of the half-bridge output voltage calculator 81 (shown in FIG. 9) according to embodiment 3 additionally having this correction function will be described. Among the application voltage references v₁* to v₆* for the respective coils, the first half-bridge output voltage reference v₁* is set to 0 initially. Then, pre-correction half-bridge output voltage references v₁₂* to v₁₇* are sequentially calculated by the adders. Then, a voltage corrector 85 calculates an appropriate corrected half-bridge output voltage reference v₁₁** from the half-bridge output voltage references v₁₁** to v₁₇*. Then, corrected half-bridge output voltage references v₁₂** to v₁₇** are sequentially calculated by adders on the basis of the corrected half-bridge output voltage reference v₁₁** as a corrected reference voltage and are sequentially outputted.

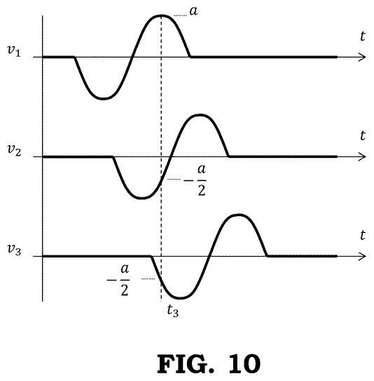

Here, changes in the waveforms of the induced voltages of the respective coils according to the relationship between the magnetic-pole pitch of the movable element and the distance between the coils in the linear motor, will be described. The voltage waveforms shown in FIG. 5 are obtained in the case of a linear motor in which the magnetic-pole pitch of the movable element and the distance between adjacent ones of the independently wound coils are equal to each other. In this case, sine waves generated in the adjacent ones of the coils have waveforms with phases shifted from each other by 180°. Meanwhile, FIG. 10 shows an example of the waveforms of induced voltages of the respective coils in a case where the magnetic-pole pitch is 1.5 times the distance between adjacent ones of the coils unlike in FIG. 5. In this case, the pre-correction half-bridge output voltage references v₁₁* to v₁₇* at a time point ta are as follows.

$${v}_{11}^{*} = 0 \\ {v}_{12}^{*} = {v}_{11}^{*} + {v}_{1}^{*} = a \\ {v}_{13}^{*} = {v}_{12}^{*} + {v}_{2}^{*} = a / 2 \\ {v}_{14}^{*} = {v}_{13}^{*} + {v}_{3}^{*} = 0 \\ {v}_{15}^{*} = {v}_{14}^{*} + {v}_{4}^{*} = 0 \\ {v}_{16}^{*} = {v}_{15}^{*} + {v}_{5}^{*} = 0 \\ {v}_{17}^{*} = {v}_{16}^{*} + {v}_{6}^{*} = 0$$

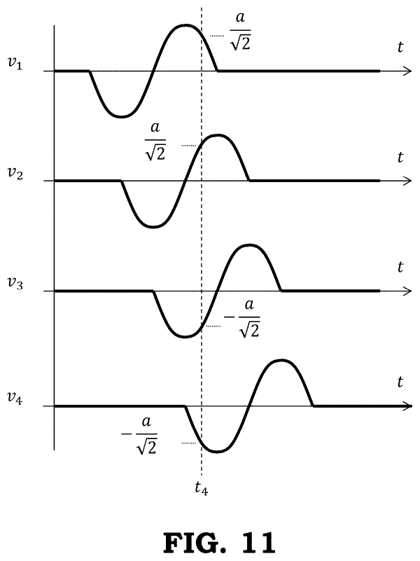

In addition, FIG. 11 shows an example of the waveforms of induced voltages of the respective coils in a case where the magnetic-pole pitch is 2 times the distance between adjacent ones of the coils. In this case, the pre-correction half-bridge output voltage references v₁₁* to v₁₇* at a time point ta are as follows.

$${v}_{11}^{*} = 0 \\ {v}_{12}^{*} = {v}_{11}^{*} + {v}_{1}^{*} = a / √ 2 \\ {v}_{13}^{*} = {v}_{12}^{*} + {v}_{2}^{*} = 2 a / √ 2 \\ {v}_{14}^{*} = {v}_{13}^{*} + {v}_{3}^{*} = a / √ 2 \\ {v}_{15}^{*} = {v}_{14}^{*} + {v}_{4}^{*} = 0 \\ {v}_{16}^{*} = {v}_{15}^{*} + {v}_{5}^{*} = 0 \\ {v}_{17}^{*} = {v}_{16}^{*} + {v}_{6}^{*} = 0$$

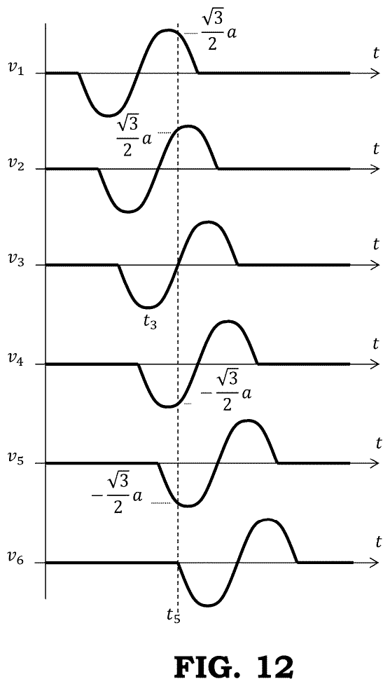

Furthermore, FIG. 12 shows an example of the waveforms of induced voltages of the respective coils in a case where the magnetic-pole pitch is 3 times the distance between adjacent ones of the coils. In this case, the pre-correction half-bridge output voltage references v₁₁* to v₁₇* at a time point t₅ are as follows.

$${v}_{11}^{*} = 0 \\ {v}_{12}^{*} = {v}_{11}^{*} + {v}_{1}^{*} = √ 3 a / 2 \\ {v}_{13}^{*} = {v}_{12}^{*} + {v}_{2}^{*} = √ 3 a \\ {v}_{14}^{*} = {v}_{13}^{*} + {v}_{3}^{*} = 0 \\ {v}_{15}^{*} = {v}_{14}^{*} + {v}_{4}^{*} = √ 3 a / 2 \\ {v}_{16}^{*} = {v}_{15}^{*} + {v}_{5}^{*} = 0 \\ {v}_{17}^{*} = {v}_{16}^{*} + {v}_{6}^{*} = 0$$

In a case where the magnetic-pole pitch of the movable element and the distance between adjacent ones of the coils are equal to each other as shown in FIG. 5, the difference between the maximum value and the minimum value among the half-bridge output voltage references v₁₁′ to v₁₇* is equal to the amplitude a of the induced voltage of each of the coils. Likewise, in a case where the magnetic-pole pitch of the movable element is 1.5 times the distance between adjacent ones of the coils as shown in FIG. 10, the difference between the maximum value and the minimum value among the half-bridge output voltage references v₁₁* to v₁₇* is equal to the amplitude a of the induced voltage of each of the coils. In these cases, when the half-bridge output voltage calculator 81 including the voltage corrector 85 according to embodiment 3 is used, the half-bridge output voltages follow the modulation factors until a bus voltage V_{dc} and the amplitude a of the induced voltage of each of the coils become equal to each other, whereby a correct voltage can be outputted. This is equivalent to a range of voltages that the full-bridge circuits can apply to the coils. Even when a plurality of the movable elements are being moved, in a case where the movable elements are being moved in the same direction, the difference between the maximum value and the minimum value among the necessary half-bridge output voltage references v₁₁* to v₁₇* is, as described in embodiment 2, equal to the amplitude a of an induced voltage generated by the movable element that is being moved at the highest speed, whereby voltage output does not become difficult. Meanwhile, in a case where the movable elements are being moved in opposite directions, the signs of the respective induced voltages are opposite to each other so that the output voltage range is restricted, but, from the viewpoint of the actual device motion, it is unlikely that a plurality of movable elements are moved in opposite directions at high speeds on the same route formed by a finite number of coils, and thus the restriction of the output voltage range does not occur in practical use.

Meanwhile, in a case where the magnetic-pole pitch of the movable element is 2 times the distance between adjacent ones of the coils as shown in FIG. 11, the difference between the maximum value and the minimum value among the half-bridge output voltage references v₁₁* to v₁₇* is 2a/√2, and, in a case where the magnetic-pole pitch of the movable element is 3 times the distance between adjacent ones of the coils, the difference between the maximum value and the minimum value among the half-bridge output voltage references v₁₁* to v₁₇* is √3a. Thus, the amplitude a of the induced voltage of each of the coils is exceeded. In these cases, the range, of the amplitudes of induced voltages of the respective coils, in which the linear motor drive device according to the present disclosure can be normally operated becomes narrower than that of the conventional full-bridge circuit. Consequently, the maximum movement speed of the movable element has to be decreased, or otherwise restrictions are imposed on operation. In particular, in the case where the magnetic-pole pitch of the movable element is 3 times the distance between adjacent ones of the coils, the advantageous effect of widening the range of coil application voltages in the present disclosure is hardly exhibited with respect to the half-bridge circuits. As the extent to which the magnetic-pole pitch of the movable element is longer than the distance between adjacent ones of the coils becomes larger, the restrictions on operation become more severe. Thus, in the linear motor to which the linear motor drive device according to the present disclosure is applied, appropriate design is such that the magnetic-pole pitch of the movable element is desirably set to be equal to or shorter than 1.5 times the distance between adjacent ones of the coils, and, in consideration of advantages in terms of cost and size, the magnetic-pole pitch is set to be equal to or shorter than 2.5 times said distance.

In the linear motor drive device according to the present disclosure, the restrictions on operation of the movable element due to the half-bridge output voltages described above can be avoided also by, for example, changing the manner of connection between the drive circuit and the coils, e.g., by winding adjacent ones of the coils in opposite directions so as to invert the signs of induced voltages to be generated or by, regarding the order of connection between the half-bridges and the coils, performing alternate connection to distant coils instead of sequential connection so as to invert the signs of the induced voltages of the coils generated between adjacent ones of the half-bridges. With such a manner of connection between the drive circuit and the coils, although restrictions on voltage are mitigated, the currents flowing through the half-bridges increase. This manner of connection can be included as a choice in designing.

The above actions enable the linear motor drive device according to embodiment 3 to, as compared to a conventional drive device (such as one described in, for example, Patent Document 1), significantly decrease the number of necessary switches and, for the linear motor subject to appropriate design conditions, apply voltages equal to or close to those in the conventional device to the respective coils. Consequently, it is possible to realize the same functions as those of the conventional type while decreasing the size of and cost for the drive device.

### Embodiment 4

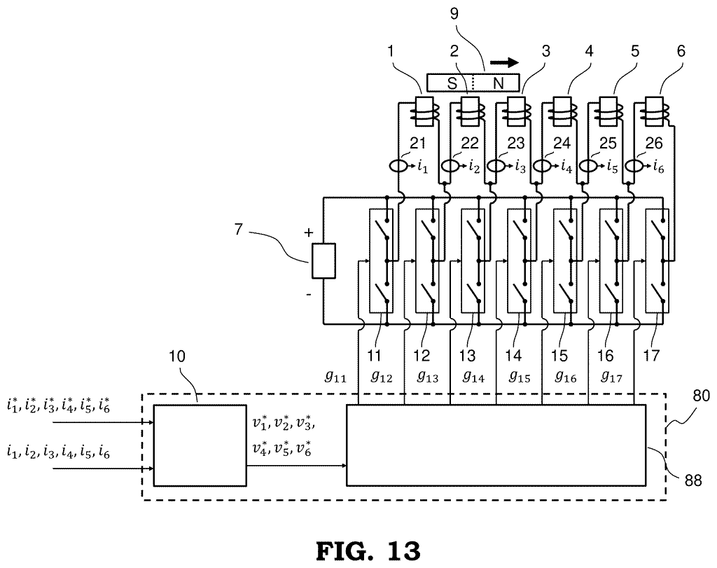

FIG. 13 shows a configuration of a linear motor drive device according to embodiment 4. In addition to the constituents shown in FIG. 3, the present configuration includes: current sensors 21 to 26 which detect currents flowing through the respective coils 1 to 6 and output respective coil current measurement values i₁ to i₆; and a current controller 10 which calculates application voltage references v₁* to v₆* for the respective coils on the basis of current references for the respective coils (hereinafter, referred to as coil current references) i₁* to i₆* and the coil current measurement values i₁ to i₆, and outputs the application voltage references v₁* to v₆*. Here, a switching controller 80 is composed of: a controller 88 having the same function as that of the switching controller 8 shown in FIG. 3 or FIG. 7; and the current controller 10. The coil current references i₁* to i₆* are given from a higher-order controller (not shown) in order to control the thrust to be generated by the movable element 9 and the position and the speed of the movable element. The current controller 10 is a group of controllers which perform control through adjustment of the application voltage references v₁* to v₆* for the respective coils 1 to 6 such that the coil current references i₁* to i₆* and the coil current measurement values i₁ to i₆ respectively become equal to each other. For example, the current controller 10 is a current feedback controller that calculates, for current of each of the coils, a deviation between the corresponding current reference and the corresponding current measurement value and that outputs an application voltage reference for the coil via a proportional-integral controller.

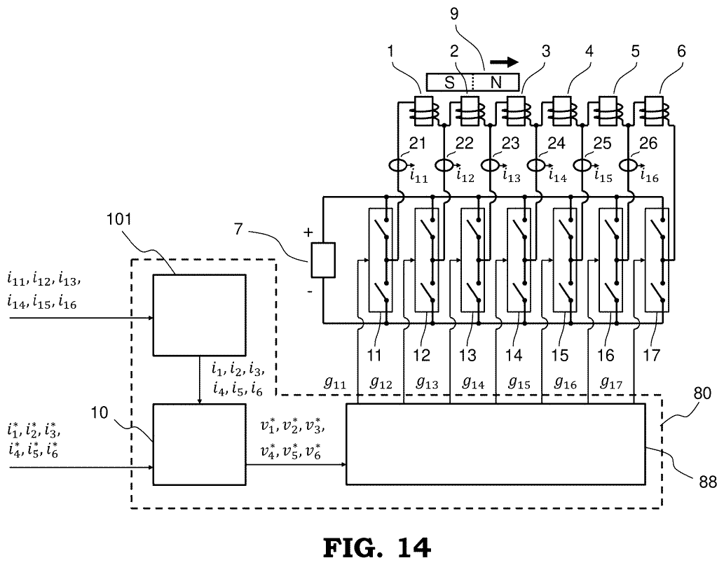

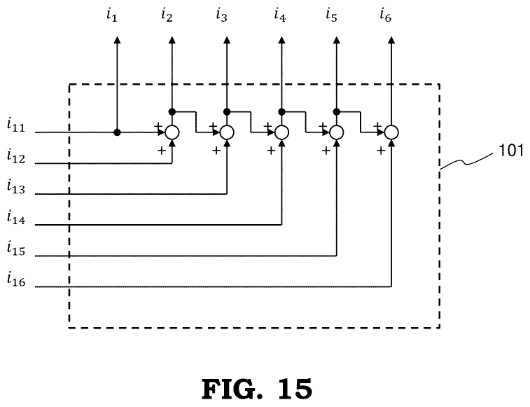

In FIG. 14, the currents to be detected by the current sensors 21 to 26 have been changed from currents of the respective coils 1 to 6 to output currents of the respective half-bridges 11 to 16, and the current sensors 21 to 26 output respective half-bridge current signals i₁₁ to i₁₆. The half-bridge current signals in to its are inputted to a coil current calculator 101 which calculates and outputs respective coil current measurement values i₁ to i₆. Here, the switching controller 80 is composed of: the controller 88 having the same function as that of the switching controller 8 shown in FIG. 3 or FIG. 7; the current controller 10; and the coil current calculator 101. FIG. 15 shows an internal structure of the coil current calculator 101. On the basis of the relationship in connection between the coils 1 to 6 and the half-bridges 11 to 16, the coil current measurement values i₁ to i₆ are calculated from the respective half-bridge current signals i₁₁ to i₁₆ according to the following expressions.

$${i}_{1} = {i}_{11} \\ {i}_{2} = {i}_{1} + {i}_{12} \\ {i}_{3} = {i}_{2} + {i}_{13} \\ {i}_{4} = {i}_{3} + {i}_{14} \\ {i}_{5} = {i}_{4} + {i}_{15} \\ {i}_{6} = {i}_{5} + {i}_{16}$$

As described above, the coil current measurement values are calculated from the half-bridge current signals, whereby connection between the coils does not have to be made in the drive circuit, and the number of terminals for connection between the drive circuit and the coils can be decreased. Alternatively, instead of providing the current sensors on the output sides of the respective half-bridge circuits as shown in FIG. 14, a type may be employed in which: a current detection resistor is interposed at a connection portion between each of the half-bridges and a negative terminal of the DC power supply so as to enable current detection; and current detection is performed at a position at which the corresponding coil is connected to the negative terminal of the DC power supply, by switching of the half-bridge circuit. With this type, a signal equivalent to each of the half-bridge current signals is obtained with a voltage signal for which the potential of the negative terminal of the DC power supply is regarded as a common potential. Consequently, it is possible to realize an equivalent performance by using less expensive parts.

By the above actions, the linear motor drive device according to embodiment 4 performs control according to current references such that the coil currents become equal to the respective reference values. Consequently, the linear motor can be controlled with a higher accuracy. In addition, use of the coil current calculator which calculates coil currents from the respective half-bridge circuit output currents makes it possible to realize the same functions as those of the conventional type (such as one described in, for example, Patent Document 1) while decreasing the number of the terminals for connection between the drive circuit and the coils.

### Embodiment 5

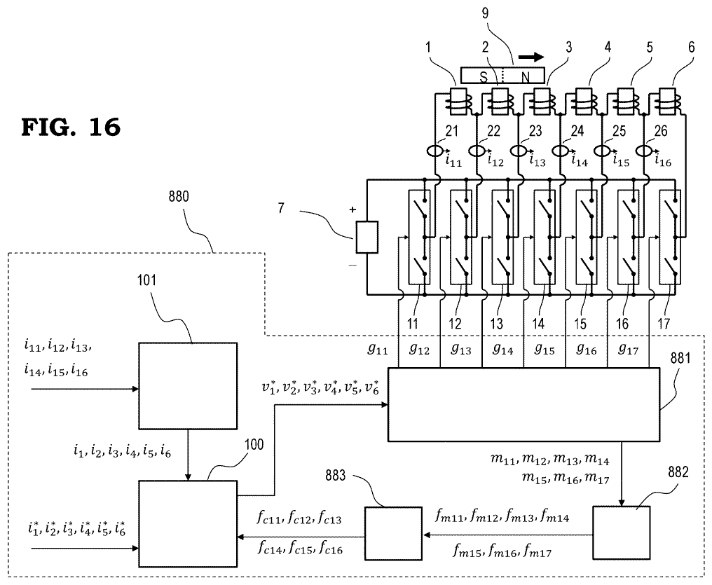

FIG. 16 shows a configuration of a linear motor drive device according to embodiment 5. In addition to the constituents shown in FIG. 14, the present configuration includes: a controller 881 which has the same function as that of the switching controller 8 shown in FIG. 3 or FIG. 7 and which further outputs the half-bridge modulation factors m₁₁ to m₁₇; a modulation factor saturation detector 882 which detects the half-bridge modulation factors m₁₁ to m₁₇ and which outputs respective modulation factor saturation signals fm₁₁ to fm₁₇; and a coil voltage saturation detector 883 which detects the modulation factor saturation signals fm₁₁ to fm₁₇ and which outputs respective coil voltage saturation signals fc₁₁ to fc₁₆. In the present embodiment 5, a switching controller 880 is composed of: the controller 881; the modulation factor saturation detector 882; the coil voltage saturation detector 883; the coil current calculator 101 shown in FIG. 14; and a current controller 100 which calculates application voltage references v₁* to v₆* for the respective coils on the basis of the respective coil current references i₁* to i₆*, the respective coil current measurement values i₁ to i₆, and the respective saturation signals fc₁₁ to fc₁₆ detected by the coil voltage saturation detector 883.

The modulation factor saturation detector 882 has functions of: detecting the modulation factors m₁₁ to m₁₇; outputting, when the absolute value of any of the modulation factors m₁₁ to m₁₇ is larger than 1, 1 as a corresponding one of modulation factor saturation signals fm₁₁ to fm₁₇ based on the respective modulation factors m₁₁ to m₁₇; and outputting, when the absolute value of any of the modulation factors m₁₁ to m₁₇ is smaller than 1, 0 as a corresponding one of said modulation factor saturation signals fm₁₁ to fm₁₇. The coil voltage saturation detector 883 detects the modulation factor saturation signals fm₁₁ to fm₁₇ outputted from the modulation factor saturation detector 882 and converts the modulation factor saturation signals into respective coil voltage saturation signals, to output respective coil voltage saturation signals fc₁₁ to fc₁₆ each of which is 1 or 0. The current controller 100 is a group of controllers which perform control through adjustment of the application voltage references v₁* to v₆* for the respective coils 1 to 6 such that the coil current references i₁* to i₆* and the coil current measurement values i₁ to i₆ respectively become equal to each other, in the same manner as the current controller 10 shown in FIG. 14. The current controller 100 is a current feedback controller that calculates, for each of the coils, a deviation between the corresponding current reference and the corresponding current measurement value and that outputs an application voltage reference for the coil via a proportional calculator and an integral calculator. Furthermore, the current controller 100 has a function of: detecting, by the integral calculator, the coil voltage saturation signals fc₁₁ to fc₁₆ outputted from the coil voltage saturation detector 883; and, when any of the detected coil voltage saturation signals fc₁₁ to fc₁₆ is 1, stopping integral calculation being performed by the integral calculator or performing an update.

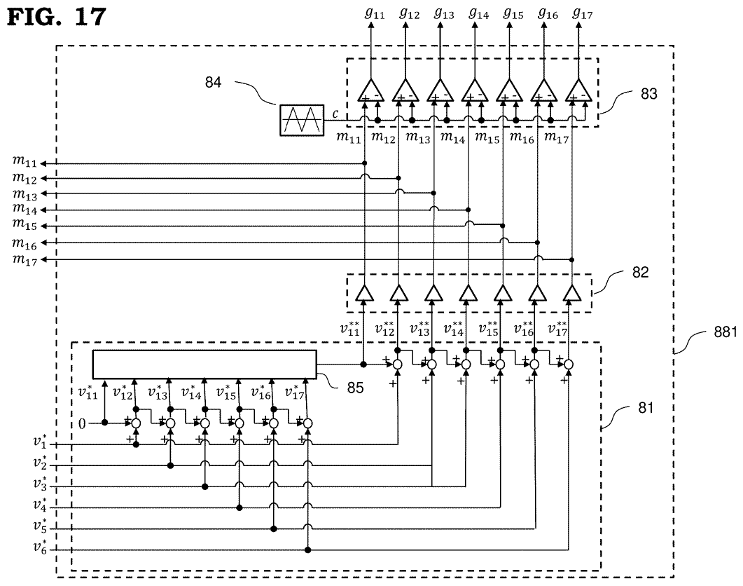

FIG. 17 shows an internal structure of the controller 881 shown in FIG. 16. The controller 881 has the same function as that of the switching controller 8 shown in FIG. 3 or FIG. 7 and further has a function of outputting the modulation factors m₁₁ to m₁₇ calculated by the modulation factor calculator 82.

In order to explain an advantageous effect of the current controller 100 shown in FIG. 16, description will be given regarding a case where, when the movable element 9 passes over the coils 1 to 6 and the speed of the movable element becomes 3/2 times at a time point t₆, an induced voltage generated in each of the coils becomes larger than a voltage that can be outputted.

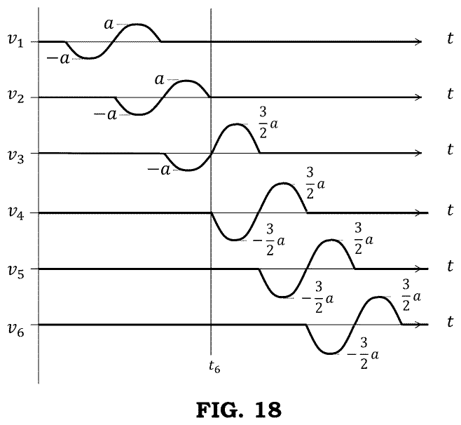

FIG. 18 shows the waveforms of induced voltages that, when the movable element 9 passes over the coils 1 to 6 and the speed of the movable element becomes 3/2 times at the time point t₆, have been generated in the coils. In FIG. 18, the waveform of the induced voltage of the coil 1 is represented by v₁, the waveform of the induced voltage of the coil 2 is represented by v₂, the waveform of the induced voltage of the coil 3 is represented by v₃, the waveform of the induced voltage of the coil 4 is represented by v₄, the waveform of the induced voltage of the coil 5 is represented by v₅, the waveform of the induced voltage of the coil 6 is represented by v₆, and the horizontal axis indicates time point t (elapse of time).

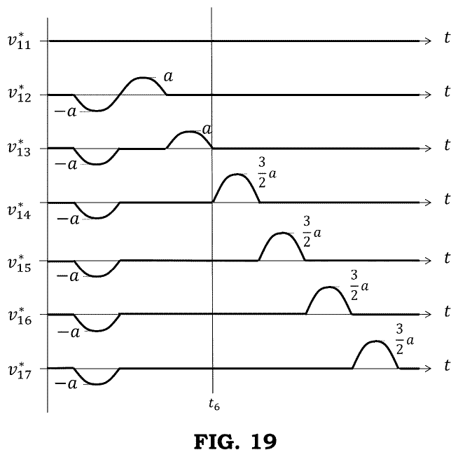

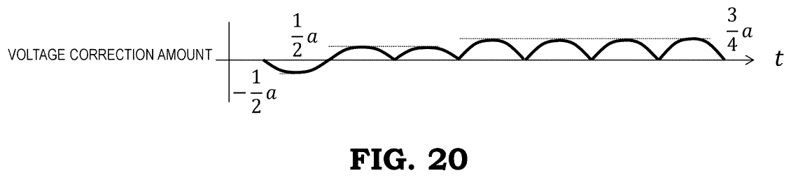

In order to, for example, prevent the movable element 9 from generating any thrust at this time, voltages equal to the induced voltages of the respective coils only have to be applied to the coils in the same manner as in embodiment 3. In this case, application voltage references for these voltages are inputted to the half-bridge output voltage calculator 81 of the controller 881, and waveforms of respective half-bridge output voltage references v₁₁* to v₁₇* shown in FIG. 19 are calculated. The calculated waveforms of the respective half-bridge output voltage references v₁₁* to v₁₇* are inputted to the voltage corrector 85 which then calculates a voltage correction amount shown in FIG. 20.

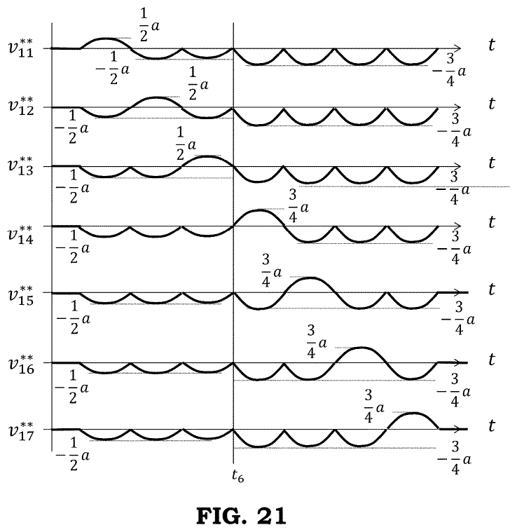

Corrected half-bridge output voltage references v₁₁** to v₁₇** shown in FIG. 21 indicate waveforms resulting from applying the voltage correction amount shown in FIG. 20 to the respective half-bridge output voltage references v₁₁* to v₁₇* by the voltage corrector 85. Since the voltage correction amount has been applied, the maximum value and the minimum value among the corrected half-bridge output voltage references v₁₁** to v₁₇** are respectively a/2 and −a/2 before the speed of the movable element becomes 3/2 times at the time point t₆. After the speed of the movable element becomes 3/2 times at the time point t₆, the maximum value and the minimum value among the corrected half-bridge output voltage references v₁₁** to v₁₇** respectively become 3a/4 and −3a/4.

In this situation in FIG. 21, it is assumed that the induced voltages have been increased at the time point t₆ or a subsequent time point, and, in association with this increase, the corrected half-bridge output voltage references v₁₁** to v₁₇** are increased and the absolute values of the respective half-bridge modulation factors m₁₁ to m₁₇ calculated by the modulation factor calculator 82 shown in FIG. 17 have become larger than 1.

In this case, the controller 881 shown in FIG. 16 outputs 1 as each of the modulation factor saturation signals fc₁₁ to f_{c16} at the time point t₆ or a subsequent time point. The coil voltage saturation detector 883 receives the modulation factor saturation signals fm₁₁ to fm₁₇ outputted from the modulation factor saturation detector 882 and outputs respective coil voltage saturation signals fc₁₁ to fc₁₆. The input/output relationship between the modulation factor saturation signals fm₁₁ to fm₁₇ and the coil voltage saturation signals fc₁₁ to fc₁₆ is as follows.
In the case of fm₁₁=1, the output is fc₁₁=1.
In the case of fm₁₂=1, the output is fc₁₁=1 and fc₁₂=1.
In the case of fm₁₃=1, the output is fc₁₂=1 and fc₁₃=1.
In the case of fm₁₄=1, the output is fc₁₃=1 and fc₁₄=1.
In the case of fm₁₅=1, the output is fc₁₄=1 and fc₁₅=1.
In the case of fm₁₆=1, the output is fc₁₅=1 and fc₁₆=1.
In the case of fm₁₇=1, the output is fc₁₆=1.

In cases other than the above cases, 0 is outputted as each of the coil voltage saturation signals. Although the case where the absolute values of all the half-bridge modulation factors m₁₁ to m₁₇ are larger than 1 has been described above as an example, there is also a case where the absolute value of the modulation factor for only one of the half-bridges is larger than 1. In this case, the coil voltage saturation signal for a coil connected to the half-bridge, the modulation factor for which is larger than 1, is set to 1.

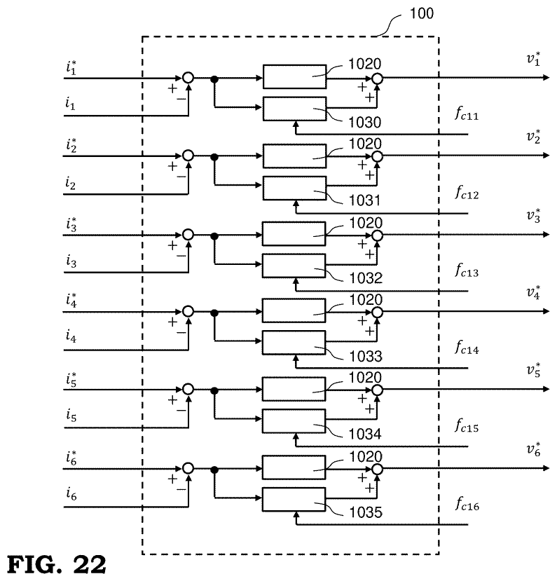

FIG. 22 shows an internal structure of the current controller 100 for achieving the function described above. The current controller 100 has a function of adding up: an output obtained by each of proportional calculators 1020 which performs proportional multiplication of the deviation between the corresponding one of the coil current references i₁* to i₆* and the corresponding one of the coil current measurement values i₁ to i₆; and an output obtained by the corresponding one of integral calculators 1030 to 1035 which performs integral calculation of said deviation. As shown in FIG. 22, the coil voltage saturation signals fc₁₁ to fc₁₆ are inputted to the current controller 100.

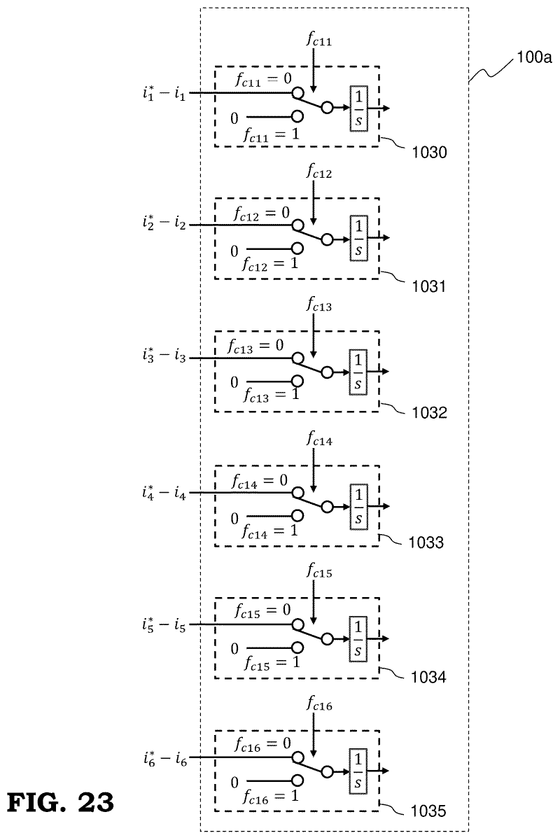

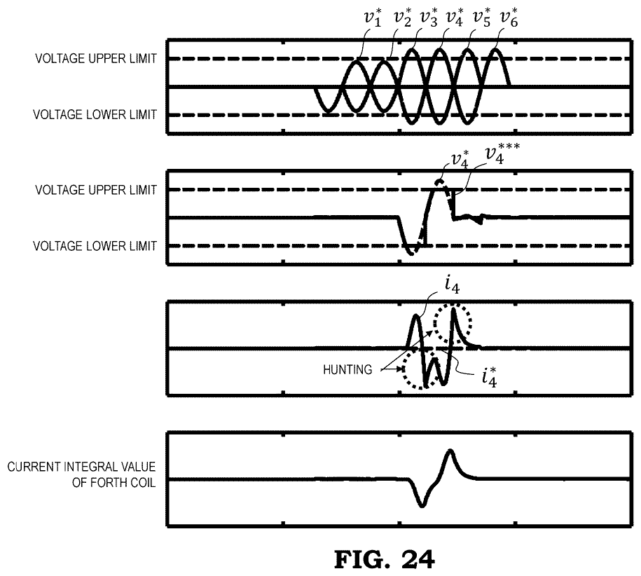

FIG. 23 shows internal structures of the integral calculators 1030 to 1035 provided in the current controller 100. In FIG. 23, the group of integral calculators is represented by 100a. Regarding each of the integral calculators 1030 to 1035, whether an integrator (the block represented by 1/s in FIG. 22) of the integral calculator receives the deviation between the corresponding one of the coil current references i₁* to i₆* and the corresponding one of the coil current measurement values i₁ to i₆ or receives 0 is determined according to the corresponding one of the coil voltage saturation signals fc₁₁ to fc₁₆. Specifically, when the coil voltage saturation signal for the integrator among the coil voltage saturation signals fc₁₁ to fc₁₆ has a value of 1, the integrator receives 0 (i.e., stops integral calculation), whereas, when the coil voltage saturation signal for the integrator among the coil voltage saturation signals fc₁₁ to fc₁₆ has a value of 0, the integrator receives the deviation between the corresponding one of the coil current references i₁* to i₆* and the corresponding one of the coil current measurement values i₁ to i₆. Since, when 1 is inputted as the coil voltage saturation signal for the integrator among the coil voltage saturation signals fc₁₁ to fc₁₆, the integrator receives 0 so as to stop integral calculation in a voltage saturation section, hunting in the coil current measurement value can be inhibited from occurring as a result of outputting a current integral value accumulated in the integrator, when the corresponding one of the coil voltage saturation signals fc₁₁ to fc₁₆ is switched from 1 to 0. The hunting refers to a phenomenon in which current oscillates as shown in FIG. 24.

FIG. 24 shows the application voltage references v₁* to v₆* for the respective coils, the application voltage reference v₄* for and the coil application voltage v₄*** of the coil 4, the coil current reference i₄* for and the coil current measurement value i₄ of the coil 4, and a current integral value calculated by the integral calculator 1033 shown in FIG. 23 from the deviation between the coil current reference i₄* and the coil current measurement value i₄ in a case where integral calculation being performed by the current controller is not stopped in the section in which 1 is outputted as each of the coil voltage saturation signals fc₁₁ to fc₁₆. The application voltage reference v₄* for the coil 4 is larger than the voltage that can be outputted. Thus, the voltage equal to said reference cannot be applied. Accordingly, the coil current measurement value i₄ also cannot be set to the current equal to the corresponding reference value. In addition, since the integral calculation is not stopped in the section in which 1 is outputted as the coil voltage saturation signal fc₁₄, the deviation between the coil current reference i₄* and the coil current measurement value i₄ continues to be integrated. Then, upon switching of the coil voltage saturation signal fc₁₄ from 1 to 0, the current integral value accumulated in the integral calculator 1033 is outputted. Consequently, hunting occurs in the current measurement value i₄, whereby the coil current measurement value i₄ reaches the coil current reference i₄* later.

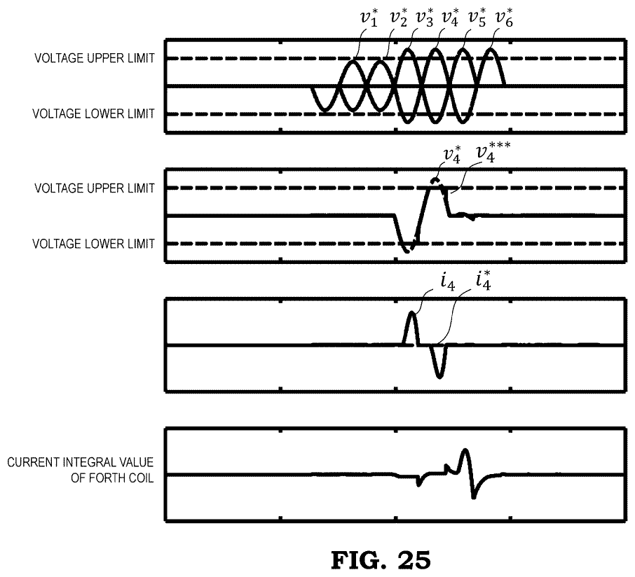

FIG. 25 shows the application voltage references v₁* to v₆* for the coils, the application voltage reference v₄* for and the coil application voltage v₄*** of the coil 4, the coil current reference i₄* for and the coil current measurement value i₄ of the coil 4, and the current integral value calculated by the integral calculator 1033 shown in FIG. 23 from the deviation between the coil current reference i₄* and the coil current measurement value i₄ in a case where integral calculation being performed by the current controller is stopped in the section in which 1 is outputted as each of the coil voltage saturation signals fc₁₁ to fc₁₆. Since the integral calculation is stopped in the section in which 1 is outputted as the coil voltage saturation signal fc₁₄, the current integral value to be outputted from the integral calculator upon switching of the coil voltage saturation signal fc₁₄ from 1 to 0 is decreased. Therefore, hunting in the coil current measurement value i₄ is suppressed as compared to the case in FIG. 24.

In this case, in order to further suppress hunting in the current measurement value i₄, it is desirable to, instead of stopping the integral calculator in the section in which 1 is outputted as the coil voltage saturation signal fc₁₄, update the integral calculation value to a value different from the value resulting from previously-performed integration, such that an appropriate integral calculation value is obtained when the voltage saturation section ends. By performing this processing, hunting in the current measurement value after the voltage saturation section ends, can be further suppressed, and the reaching of the coil current measurement value i₄ occurs earlier.

As described above, the linear motor drive device according to embodiment 5 is such that, for each of the coils, the application voltage reference for the coil is created by a current controller having a corresponding integral calculator that receives a deviation between the measurement value of the current flowing through the coil and the current reference for the coil, and, when a modulation factor for a half-bridge among the plurality of half-bridges has an absolute value larger than 1, the current controller stops integral calculation being performed by the integral calculator for a coil (corresponding to, in the case of a half-bridge to which two coils are connected such as any of the half-bridge 12 to 16, the two coils or corresponding to, in the case of a half-bridge that is located at either of both ends and to which only one coil is connected such as the half-bridge 11 or 17, the one coil) connected to the half-bridge among the coils or updates, to a different value, a value resulting from integration previously performed by the integral calculator. Consequently, hunting in the current of the coil is suppressed.

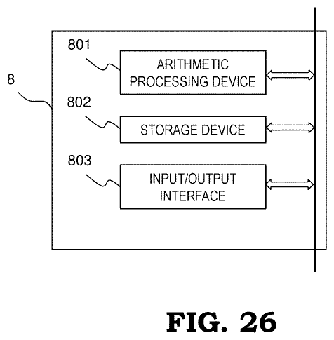

As shown in FIG. 26, each of the switching controllers in the above embodiments specifically includes: an arithmetic processing device 801 such as a central processing unit (CPU); a storage device 802 in which data is received from and transmitted to the arithmetic processing device 801; an input/output interface 803 through which a signal is inputted/outputted between the arithmetic processing device 801 and the outside; and the like. As the arithmetic processing device 801, an application specific integrated circuit (ASIC), an integrated circuit (IC), a digital signal processor (DSP), a field programmable gate array (FPGA), any type of signal processing circuit, etc., may be provided. Also, a plurality of the arithmetic processing devices 801 of the same type or different types may be provided so as to execute allocated respective processes. As the storage device 802, a random access memory (RAM) configured to be able to read and write data with respect to the arithmetic processing device 801, a read only memory (ROM) configured to be able to read data from the arithmetic processing device 801, etc., are provided. The input/output interface 803 is composed of, for example: an interface for inputting the application voltage references v₁* to v₆* or the current references i₁* to i₆* for the respective coils to the arithmetic processing device 801; an A/D converter for inputting the coil current measurement values i₁ to i₆ from the respective current sensors 21 to 26 to the arithmetic processing device 801; a drive circuit for outputting drive signals to the respective switching elements; and the like.

Although various exemplary embodiments and examples are described in the present application, various features, aspects, and functions described in one or more embodiments are not inherent in a particular embodiment, and can be applicable alone or in their various combinations to each embodiment. Accordingly, countless variations that are not illustrated are envisaged within the scope of the art disclosed herein. For example, the case where at least one component is modified, added or omitted, and the case where at least one component is extracted and combined with a component in another embodiment are included.

### DESCRIPTION OF THE REFERENCE CHARACTERS

1, 2, 3, 4, 5, 6 coil
7 DC power supply
8, 80, 880 switching controller
9 movable element
10, 100 current controller
11, 12, 13, 14, 15, 16, 17 half-bridge
21, 22, 23, 24, 25, 26 current sensor
81 half-bridge output voltage calculator
85 voltage corrector
101 coil current calculator
1030 to 1035 integral calculator
i₁, i₂, i₃, i₄, i₅, i₆ coil current measurement value
i₁*, i₂*, i₃*, i₄*, i₅*, i₆* coil current reference
v₁*, v₂*, v₃*, v₄*, v₅*, v₆* application voltage reference
v₁₁*, v₁₂*, v₁₃*, v₁₄*, v₁₅*, v₁₆*, v₁₇* half-bridge output voltage reference
m₁₁, m₁₂, m₁₃, m₁₄, m₁₅, m₁₆, m₁₇ half-bridge modulation factor

1. A linear motor drive device comprising:
a stator on which a plurality of coils are disposed to be arrayed;
half-bridges each formed by a series unit of a plurality of switches, the number of the half-bridges being larger, by one, than the number of the coils; and
a switching controller including a half-bridge output voltage calculator, wherein
the plurality of coils are electrically connected in series,
both ends of a series unit of the coils connected in series and connection points between the coils are each connected to an output point of a different one of the half-bridges,
both ends of each of the half-bridges are connected to a DC source,
AC voltages are applied to the respective coils,
the half-bridge output voltage calculator obtains, through calculation, output voltage references for the respective half-bridges on the basis of application voltage references for voltages to be applied to the plurality of respective coils, and
the switching controller obtains switching signals for controlling the switches of the half-bridges by using the half-bridge output voltage references for the respective half-bridges obtained by the half-bridge output voltage calculator and controls drive of the switches of all the half-bridges, and
wherein the half-bridge output voltage calculator
obtains, by using each of the application voltage references, the respective half-bridge output voltage references in order from the half-bridge output voltage reference for the half-bridge to which one of the ends of the series unit of the coils is connected,
sets, as a reference voltage, the half-bridge output voltage reference for the half-bridge to which the one of the ends of the series unit of the coils is connected, and
obtains, by using each of the application voltage references, the respective half-bridge output voltage references in order from one of the half-bridge output voltage references to another one of the half-bridge output voltage references, the one half-bridge output voltage reference being for the half-bridge connected to another end of the coil connected to the half-bridge to which the one of the ends of the series unit of the coils is connected, the other half-bridge output voltage reference being for the half-bridge connected to another one of the ends of the series unit of the coils.

2. The linear motor drive device according to claim 1, wherein each of the application voltage references is given as a waveform of a voltage.

3.-4. (canceled)

5. The linear motor drive device according to claim 1,
wherein the half-bridge output voltage calculator sets the reference voltage to 0.

6. The linear motor drive device according to claim 1, wherein the half-bridge output voltage calculator corrects the reference voltage on the basis of the half-bridge output voltage references each obtained with the reference voltage being set to 0 and obtains the respective half-bridge output voltage references.

7. The linear motor drive device according to claim 1, wherein each of the application voltage references is created on the basis of a measurement value of a current flowing through the corresponding coil and a current reference for the coil.

8. A linear motor drive device, comprising:
a stator on which a plurality of coils are disposed to be arrayed;
half-bridges each formed by a series unit of a plurality of switches, the number of the half-bridges being larger, by one, than the number of the coils; and
a switching controller including a half-bridge output voltage calculator, wherein
the plurality of coils are electrically connected in series,
both ends of a series unit of the coils connected in series and connection points between the coils are each connected to an output point of a different one of the half-bridges,
both ends of each of the half-bridges are connected to a DC source,
AC voltages are applied to the respective coils,
the half-bridge output voltage calculator obtains, through calculation, output voltage references for the respective half-bridges on the basis of application voltage references for voltages to be applied to the plurality of respective coils,
the switching controller obtains switching signals for controlling the switches of the half-bridges by using the half-bridge output voltage references for the respective half-bridges obtained by the half-bridge output voltage calculator and controls drive of the switches of all the half-bridges, and
wherein each of the application voltage references is created on the basis of a measurement value of a current flowing through the corresponding coil and a current reference for the coil, and
wherein, for each of the plurality of coils, the corresponding application voltage reference is created by a current controller having a corresponding integral calculator that receives a deviation between the measurement value of the current flowing through the coil and the current reference for the coil, and,
when a modulation factor for a half-bridge among the plurality of half-bridges has an absolute value larger than 1, the current controller stops integral calculation being performed by the integral calculator for a coil connected to the half-bridge among the coils or updates, to a different value, a value resulting from integration previously performed by the integral calculator.

9. The linear motor drive device according to claim 8, wherein the number of the coils of the stator is 4 or more.

10. A linear motor comprising:
the linear motor drive device according to claim 1; and
a movable element movably provided, with a gap between the stator and the movable element, wherein
a magnetic-pole pitch of the movable element is equal to or shorter than 2.5 times a distance between adjacent ones of the coils of the stator.

11. A linear motor comprising:
the linear motor drive device according to claim 1; and
a plurality of movable elements movably provided, with gaps between the stator and the movable elements, wherein
each of the application voltage references includes each of the application voltage references obtained when at least two of the movable elements are present at positions corresponding to the series unit of the coils.

12. The linear motor according to claim 11, wherein a magnetic-pole pitch of each of the movable elements is equal to or shorter than 2.5 times a distance between adjacent ones of the coils of the stator.

13. A linear motor comprising:
the linear motor drive device according to claim 8; and
a movable element movably provided, with a gap between the stator and the movable element, wherein
a magnetic-pole pitch of the movable element is equal to or shorter than 2.5 times a distance between adjacent ones of the coils of the stator.

14. A linear motor comprising:
the linear motor drive device according to claim 8; and
a plurality of movable elements movably provided, with gaps between the stator and the movable elements, wherein
each of the application voltage references includes each of the application voltage references obtained when at least two of the movable elements are present at positions corresponding to the series unit of the coils.

15. The linear motor according to claim 14, wherein a magnetic-pole pitch of each of the movable elements is equal to or shorter than 2.5 times a distance between adjacent ones of the coils of the stator.

16. A linear motor comprising:
a linear motor drive device comprising:
a stator on which a plurality of coils are disposed to be arrayed;
half-bridges each formed by a series unit of a plurality of switches, the number of the half-bridges being larger, by one, than the number of the coils; and
a switching controller including a half-bridge output voltage calculator,
wherein
the plurality of coils are electrically connected in series,
both ends of a series unit of the coils connected in series and connection points between the coils are each connected to an output point of a different one of the half-bridges,
both ends of each of the half-bridges are connected to a DC source,
AC voltages are applied to the respective coils,
the half-bridge output voltage calculator obtains, through calculation, output voltage references for the respective half-bridges on the basis of application voltage references for voltages to be applied to the plurality of respective coils,
the switching controller obtains switching signals for controlling the switches of the half-bridges by using the half-bridge output voltage references for the respective half-bridges obtained by the half-bridge output voltage calculator and controls drive of the switches of all the half-bridges, and
a movable element movably provided, with a gap between the stator and the movable element, wherein
a magnetic-pole pitch of the movable element is equal to or shorter than 2.5 times a distance between adjacent ones of the coils of the stator.

17. The linear motor drive device according to claim 7, wherein,
for each of the plurality of coils, the corresponding application voltage reference is created by a current controller having a corresponding integral calculator that receives a deviation between the measurement value of the current flowing through the coil and the current reference for the coil, and,
when a modulation factor for a half-bridge among the plurality of half-bridges has an absolute value larger than 1, the current controller stops integral calculation being performed by the integral calculator for a coil connected to the half-bridge among the coils or updates, to a different value, a value resulting from integration previously performed by the integral calculator.

18. The linear motor drive device according to claim 1, wherein the number of the coils of the stator is 4 or more.
